(19) United States
(12) Patent Application Publication
(10) Pub. No.: US 2005/0120533 A1
(43) Pub. Date: Jun. 9, 2005

(54) Tableware washer

(75) Inventors: Sang-Heon Yoon, Seoul (KR); Nung-Seo Park, Seoul (KR); Dae-Yeong Han, Gwangmyeong (KR); Si-Moon Jeon, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 10/976,912

(22) Filed: Nov. 1, 2004

(30) Foreign Application Priority Data
Dec. 5, 2003 (KR) 88215/2003

(51) Int. Cl. B08B 3/02

(52) U.S. Cl. 29/428; 134/58 D; 134/108; 134/198; 134/20; 134/200; 134/176; 134/179

(57) ABSTRACT

A tableware washer comprises: a case that forms an appearance; a tub arranged in the case with a washing space; a rack mounted in the tub and on which tableware is laid; an arm positioned in the tub, for spraying introduced washing water upon tableware; a sump case mounted at a lower surface of the tub and forming an accommodation space of washing water; a first conduit connected to the arm, for spraying washing water accommodated in the sump case into the tub through the arm; a main motor mounted at a lower surface of the sump case, for generating a rotational driving force; and an impeller positioned in the sump case and connected to the main motor by a rotational shaft penetrated along an up-down direction, for pumping washing water into the tub through the first conduit. The tableware washer occupies a small installation space by a compact construction, and a usage amount of washing water is decreased.

### BACKGROUND OF THE INVENTION

1. Field of the Invention

The present invention relates to a tableware washer, and more particularly, to a tableware washer capable of reducing an installation space by a compact construction and reducing an amount of water used at the time of washing tableware.

2. Description of the Conventional Art

Generally, a tableware washer is a device for automatically washing tableware, etc. at home, at a restaurant, etc. The tableware washer removes foreign materials existing at tableware, etc. by using a frictional force of water and a decomposition force of detergent. The tableware washer washes not only tableware but also cooking utensils such as a cup, a spoon, a fork, a knife, etc.

FIG. 1 is a longitudinal section view schematically showing one example of a tableware washer in accordance with the conventional art.

As shown, the conventional tableware washer includes: a body 10 having a washing space therein, the space formed as one surface of the body is opened; and a door (not shown) coupled to the body 10 for opening and closing one surface of the body 10.

The body 10 of the tableware washer includes: a case 11 that forms an appearance; a tub 12 arranged in the case 11 with a washing space; a rack 20 mounted in the tub 12 and on which tableware is laid; an arm 25 positioned in the tub 12 for spraying introduced washing water upon the tableware; and a sump case 30 mounted at a lower surface of the tub 12 and having an accommodation space for accommodating the washing water sprayed onto the tableware.

The rack 20 is up-down installed to be drawn out in order to accommodate tableware to be washed, etc. Also, the arm 25 having a nozzle 26 for spraying washing water onto tableware, etc. is rotatably installed at a lower side of the rack 20, respectively.

A filer 35 for shielding an introduction of foreign materials is provided in the sump case 30. Also, a drain pump 60 and a drain pipe 61 for discharging washing water are respectively provided at one side of the sump case 30.

A pump 50 for pumping washing water is arranged outside the sump case 30, and the pump 50 is connected to the sump case 30 by a connection pipe 40. 15 The pump 50 is connected to the arm 25 by a vertical conduit 45 thus to pump washing water.

FIG. 2 is a plane view of a sump case of a tableware washer according to another embodiment of the conventional art.

As shown, the tableware includes: a sump case 70 for accommodating washing water; a pump 80 formed at one side of the sump case 70 and providing a driving force for circulating washing water; a heater 90 installed at one side of the sump case 70 for heating washing water; a first connection pipe 75 for connecting the sump case 70 and the pump 80; a second connection pipe 85 for connecting the sump case 70 and the pump 80; and a third connection pipe 95 for connecting the heater 90 and the sump case 70.

Washing water accommodated in the sump case 70 is heated while passing through the first, second, and third connection pipes thus to be sprayed into the tub through a vertical conduit (not shown).

A water softening device 92 for changing hard water into soft water, and a counter weight 91 for preventing vibration and noise at the time of a rotation of an arm (not shown) are respectively installed at one side of the sump case 70.

A process for washing tableware of the conventional tableware will be explained as follows.

First, water is introduced into the sump case 30 from outside through an introduction conduit (not shown). The introduced water is mixed with detergent, etc. When the pump 50 is operated under a state that a certain amount of washing water is accommodated in the sump case 30, the washing water is supplied to the arm 25 through the connection pipe 40 by a suction force of the pump 50. The washing water is sprayed by the nozzle 26 provided at the rotating arm 25. The sprayed washing water collides with tableware, etc. laid on the rack 20 thus to remove foreign materials existing at the tableware, etc., and then is returned to the sump case 30. After performing the washing operation by repeating said circulation process, the washing water is discharged out through the drain pipe 61 with using the drain pump 60.

However, in the conventional tableware washer, the pump 50, the heater 90, etc. are arranged outside the sump cases 30 and 70, and the connection pipes 40, 75, 85, and 95 are used to connect them one another. According to this, it is impossible to realize a compact construction thus to have a limitation a space utility, thereby increasing the number of components, the number of fabrication processes, and a fabrication cost. Also, since the conventional tableware washer is designed to accommodate a certain amount of washing water in the pumps 50 and 80, the heater 90, the connection pipes 40, 75, 85, and 95, etc., an entire amount of washing water is increased. Additionally, since the heater 90 is connected to the sump case 70 by the connection pipes, a heat loss is increased.

### SUMMARY OF THE INVENTION

Therefore, an object of the present invention is to provide a tableware washer capable of reducing an installation space by a compact construction and reducing an amount of water used at the time of washing tableware.

To achieve these and other advantages and in accordance with the purpose of the present invention, as embodied and broadly described herein, there is provided a tableware washer comprising: a case that forms an appearance; a tub arranged in the case with a washing space; a rack mounted in the tub and on which tableware is laid; an arm positioned in the tub, for spraying introduced washing water upon tableware; a sump case mounted at a lower surface of the tub and having an accommodation space of washing water; a first conduit connected to the arm, for spraying washing water accommodated in the sump case into the tub through the arm; a main motor mounted at a lower surface of the sump case, for generating a rotational driving force; and an impeller positioned in the sump case and connected to the main motor by a rotational shaft penetrated along an up-down direction, for pumping washing water into the tub through the first conduit.

To achieve these and other advantages and in accordance with the purpose of the present invention, as embodied and broadly described herein, there is also provided an assembly method of a tableware washer comprising: a first step of mounting a tub having a washing space in a case that forms an appearance; a second step of completing a sump case assembly so that a rotational shaft of a main motor for providing a driving force for pumping washing water can be penetration-coupled to a sump case mounted at a lower surface of the tub and having an accommodation space of washing water; and a third step of inserting the sump case assembly into a penetration portion of the tub from an upper side of the tub so that a hook of the sump case can be coupled to a hook groove of the tub.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a longitudinal section view schematically showing one example of a tableware washer in accordance with the conventional art;

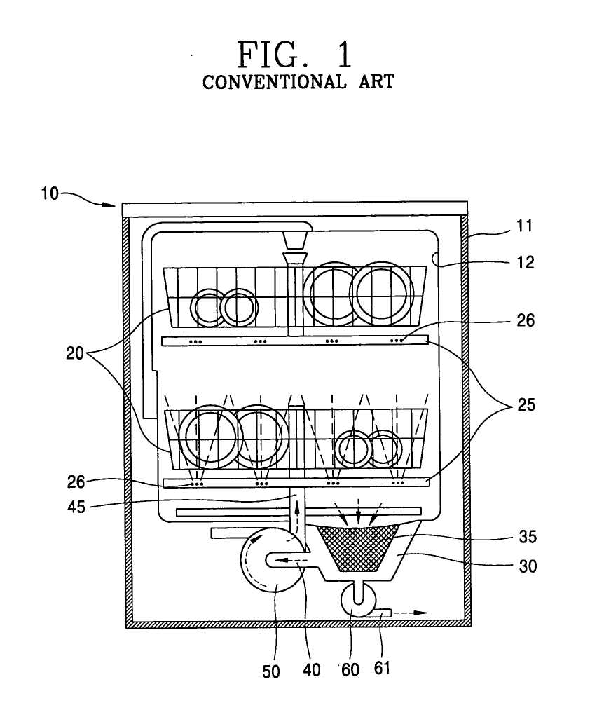

FIG. 2 is a plane view showing a sump case of a tableware washer according to another embodiment of the conventional art;

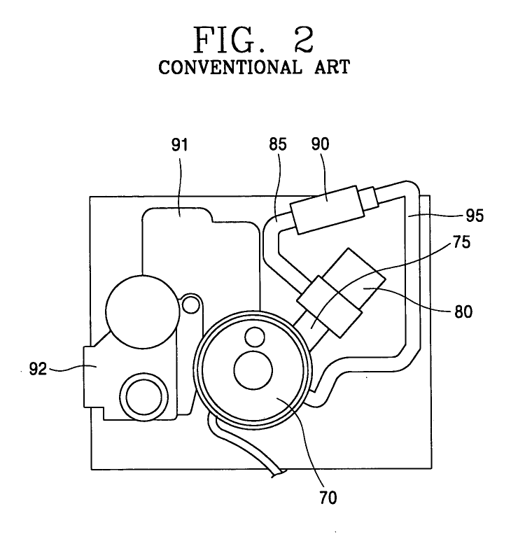

FIG. 3 is a longitudinal section view showing a tableware washer according to one embodiment of the present invention;

FIG. 4 is a longitudinal section view showing a sump case according to one embodiment of the present invention; and

FIG. 5 is a disassembled perspective view showing the sump case according to one embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

Hereinafter, a tableware washer according to the present invention will be explained with reference to the attached drawings as follows.

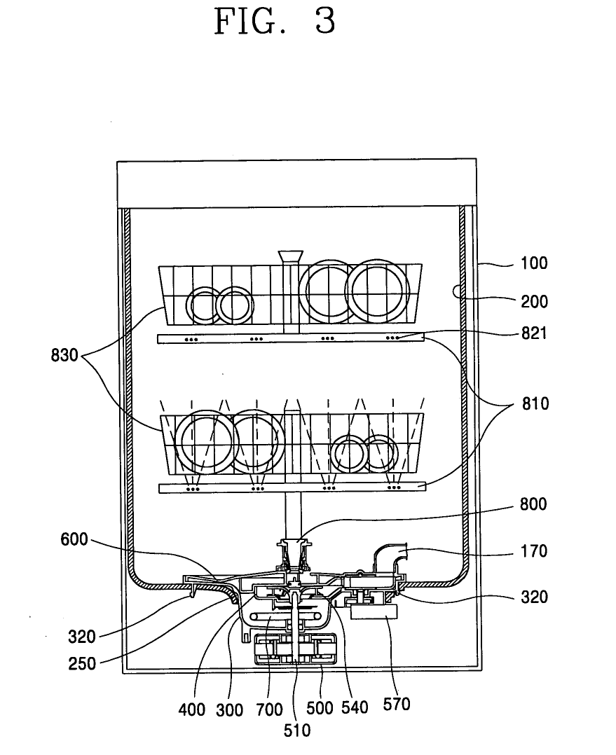

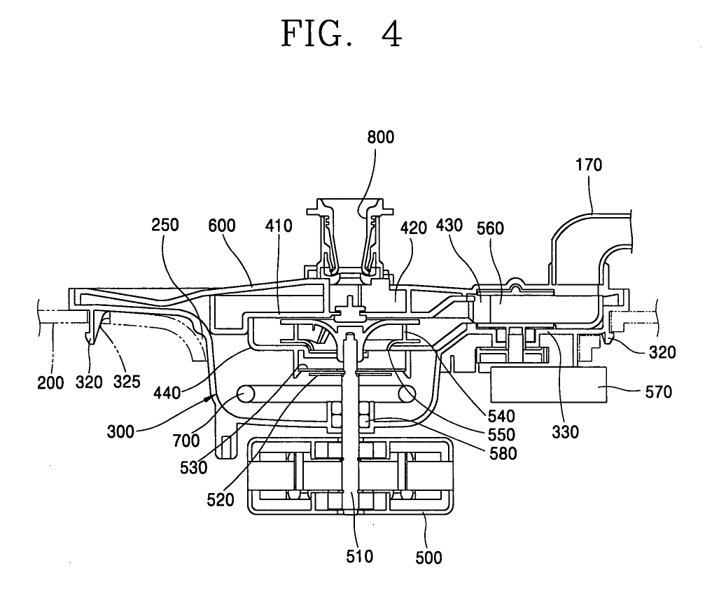

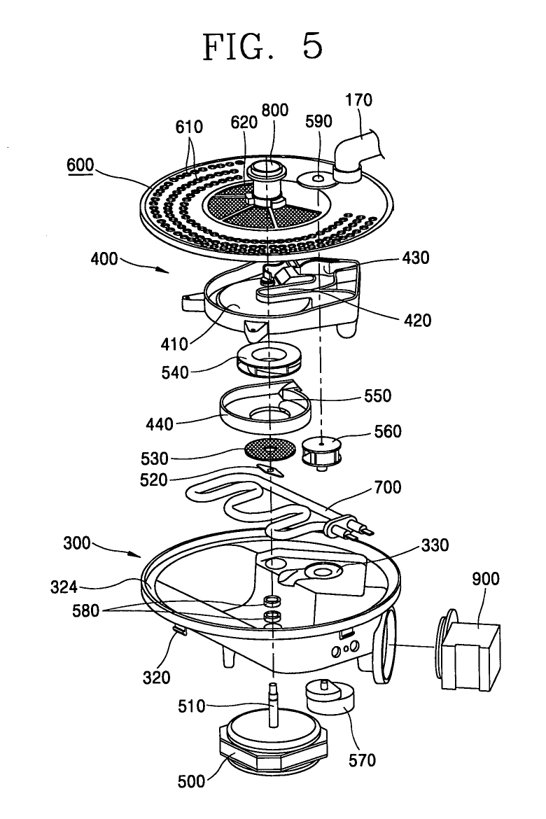

FIG. 3 is a longitudinal section view showing a tableware washer according to one embodiment of the present invention, FIG. 4 is a longitudinal section view showing a sump case according to one embodiment of the present invention, and FIG. 5 is a disassembled perspective view showing the sump case according to one embodiment of the present invention.

As shown, the tableware washer according to the present invention comprises: a case 100 that forms an appearance; a tub 200 arranged in the case 100 with a washing space; a rack 830 mounted in the tub 200 and on which tableware is laid; an arm 810 positioned in the tub 200, for spraying introduced washing water upon tableware; a sump case 300 mounted at a lower surface of the tub 200 and having an accommodation space of washing water; a first conduit connected to the arm 810, for spraying washing water accommodated in the sump case 300 into the tub 200; a main motor 500 mounted at a lower surface of the sump case 300 for generating a rotational driving force; and an impeller 540 positioned in he sump case 300 and connected to the main motor 500 by a rotational shaft 510 penetrated along an up-down direction, for pumping washing water into the tub 200 through the first conduit.

The lower surface of the tub 200 is inclined so that washing water can be collected into the sump case 300, and a penetration portion 250 is formed at the middle portion of the tub 200 so that the sump case 300 can pass and thereby can be coupled thereto. A hook groove 325 for engaging a hook 320 of the sump case 300 which will be later explained is formed at the periphery of the penetration portion 250.

A drain pump 900 is coupled to one side of the lower portion of the sump case 300, and a filter member 600 for preventing foreign materials of a certain size from being introduced into the sump case 300 is arranged at the upper end of the sump case 300. Also, a filth case 400 for collecting filth of washing water is coupled to the lower side of the filter member 600. The impeller 540 for pumping washing water by receiving a driving force is provided at the lower side of the filth case 400. A conduit control valve 560 for controlling a flow amount of pumped washing water is rotatably installed at one side of the impeller 540.

A heater 700 for heating washing water inside the sump case 300 is installed at the lower side of the impeller 540. Also, the main motor 500 having the rotational shaft 510 rotatably and integrally coupled to the axial center of the impeller 540 by penetrating the sump case 300 in the up-down direction is coupled to the lower side of the sump case 300.

The sump case 300 has a box shape that is upwardly opened to accommodate washing water therein, and a filter accommodating portion 324 for accommodating the filter member 600 is formed at the upper opened portion of the sump case 300. A plurality of hooks 320 downwardly protruded so that the sump case 300 can be coupled thereto from the upper side of the tub 200 are formed at the lower side of the filter accommodating portion 324. A valve engaging portion 330 protruded more than the periphery and rotatably engaging the conduit control valve 560 is formed at one side of the inner portion of the sump case 300. A valve driving motor 570 for rotatably driving the conduit control valve 560 by passing through the sump case 300 and thereby being integrally coupled to the conduit control valve 560 is coupled to the lower side of the valve engaging portion 330.

The filter member 600 has a disc shape, and is provided with a vertical conduit 800 at the middle portion thereof. The vertical conduit 800 is upwardly extended to supply washing water to a nozzle 821 installed at a lower portion of inside of the tub 200. A mesh portion 620 for preventing foreign materials of a IS certain size from passing, and a plurality of penetration holes 610 of a certain size are respectively formed at the periphery of the vertical conduit 800. The valve engaging portion 330 for engaging the upper end of the conduit control valve 560 is formed at one side of the vertical conduit 800. Also, an upper conduit 170 upwardly extended for supplying washing water to an upper nozzle (not shown) installed at an upper portion of inside of the tub 200 is formed at one side of the valve engaging portion 330.

The filth case 400 has a box shape that is upwardly opened, and is provided with an impeller accommodating portion 410 at one side thereof. The impeller accommodating portion 410 is protruded more than the periphery in order to accommodate the upper portion of the impeller 540. A horizontal conduit 420 for flowing washing water pumped by the impeller 540 to the vertical conduit 800 is formed at the upper side of the impeller accommodating portion 410. A valve accommodating portion 430 for accommodating the conduit control valve 560 is formed in the horizontal conduit 420.

The horizontal conduit 420 formed in the filth case 400, and the vertical conduit connected between the horizontal conduit 420 and the arm 810 form the first conduit.

An impeller case 440 for accommodating the impeller 540 together with the impeller accommodating portion 410 is coupled to the lower side of the filth case 400, and an inlet 550 for introducing washing water is penetration-formed at the lower portion of the impeller case 440. A screen 530 having introduction holes of a certain size so as to limit a size of foreign materials introduced into the inlet 550 is coupled to the inlet 550. A grinder 520 for grinding foreign materials of washing water introduced into the screen 530 is rotatably and integrally coupled to the rotational shaft 510 of the impeller 540.

The main motor 500 has a relatively thin thickness along the axial direction of the rotational shaft 510, and is formed as a BLDC motor capable of easily controlling a rotation speed. The rotational shaft 510 is rotatably supported by a bearing 580 coupled to the sump case 300.

An assembly method of the tableware washer is as follows. First, the tub 200 having a washing space is mounted in the case 100 that forms an appearance. Then, the rotational shaft 510 of the main motor 500 is penetration-coupled to the sump case 300 having the heater 700 for heating washing water. Additionally, the filth case 400 for collecting filth is coupled to the lower side of the filter member 600 for filtering filth, and the impeller case 440 for accommodating the impeller 540 is coupled to the lower side of the filth case 400. Then, the filter member 600 is coupled to the opened portion of the sump case 300 so that the impeller 540 can be coupled to the upper end of the rotational shaft 540, and the impeller 540 is fixedly-coupled to the upper end of the rotational shaft 510, thereby completing the sump case assembly. Herein, it is preferable to couple the grinder to the rotational shaft 510, to arrange the conduit control valve 560 at the valve engaging portion 330, and to couple the valve driving motor 570 to the conduit control valve 560. The completed sump case 300 is inserted into the penetration portion 250 of the tub 200 from the upper side of the tub 200 so that each hook 320 of the sump case 300 can be coupled to the hook groove 325 of the tub 200.

Hereinafter, effects of the tableware washer according to the present invention will be explained as follows. The same operation effects as those of the conventional art will be omitted.

First, water is introduced into the sump case 300 through the upper conduit 170, and the introduced water is mixed with detergent. As the pump driving motor 500 is operated, the impeller 540 is rotated. By the rotational force of the impeller 540, washing water passes through the conduit control valve 560 positioned at the valve accommodating portion 430 through the inlet 550 of the pump case 440. A desired flow amount of washing water is controlled by operating the valve driving motor 570 connected to the conduit control valve 560. The washing water that has passed through the conduit control valve 560 reaches the vertical conduit 800 and the arm 810 via the horizontal conduit 420 positioned at the filth case 400, and then is sprayed upon tableware, etc. positioned at the rack 830 through the nozzle 821. At this time, the heater 700 heats washing water positioned in the sump case 300.

As aforementioned, differently from the conventional art that the sump case is connected to the pump and the heater that are separately provided by the connection pipe, in the present invention, the pump driving motor coupled to the pump by passing through the sump case along the up-down direction is provided at the lower portion of the sump case, and the heater is positioned in the sump case. According to this, the number of components such as the heater case, the connection pipe, etc. is reduced, and a consumption amount of washing water is decreased. Also, since the sump case is assembled with a compact construction, a water softening device for converting hard water into soft water can be arranged therein. Additionally, since the heater and the sump case are integrally coupled to each other, a heat loss generated at the connection pipe can be reduced.

In the present invention, components are coupled to inside and outside of the sump case and the sump case to which components are attached is coupled to the tub, thereby facilitating the assembly between the sump case and the tub. According to this, the sump case can be conveniently assembled and can be easily repaired by separating only the sump case from the entire apparatus.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A tableware washer comprising:
a case that forms an appearance;
a tub arranged in the case with a washing space;
a rack mounted in the tub and on which tableware is laid;
an arm positioned in the tub for spraying introduced washing water upon tableware;
a sump case mounted at a lower surface of the tub and forming an accommodation space of washing water;
a first conduit connected to the arm, for spraying washing water accommodated in the sump case into the tub through the arm;
a main motor mounted at a lower surface of the sump case, for generating a rotational driving force; and
an impeller positioned in the sump case and connected to the main motor by a rotational shaft penetrated along an up-down direction, for pumping washing water into the tub through the first conduit.

2. The tableware washer of claim 1 further comprising a heater for heating washing water in the sump case.

3. The tableware washer of claim 1 further comprising a filth case positioned in the sump case with a box shape that is upwardly opened, arranged at an upper side of the impeller, and for collecting filth.

4. The tableware washer of claim 3, wherein the first conduit includes:
a horizontal conduit formed in the filth case; and
a vertical conduit connected between the horizontal conduit and the arm.

5. The tableware washer of claim 3, wherein the filth case is provided with an impeller accommodating portion for accommodating the impeller.

6. The tableware washer of claim 1 further comprising a filter member arranged at an upper end of the sump case, for preventing foreign materials of a certain size from being introduced into the sump case.

7. The tableware washer of claim 1 further comprising a conduit control valve arranged on the first conduit, for controlling a flow amount of introduced washing water.

8. The tableware washer of claim 7 further comprising a valve driving motor arranged at a lower surface of the sump case and having a rotational shaft that penetrates the sump case, for rotatably driving the conduit control valve.

9. The tableware washer of claim 1 further comprising a grinder rotatably coupled to the rotational shaft along an axial direction of the rotational shaft of the main motor at a lower side of the impeller, for grinding foreign materials of washing water introduced into the impeller.

10. The tableware washer of claim 1, wherein the sump case is provided with hooks downwardly protruded so that the sump case can be penetration-coupled to the tub from an upper side of the tub.

11. The tableware washer of claim 1 further comprising a drain pump arranged at one side of a lower portion of the sump case, for discharging washing water outwardly.

12. An assembly method of a tableware washer comprising:
completing an outer assembly so that a tub having a washing space can be mounted in a case that forms an appearance;
completing a sump case assembly so that a rotational shaft of a main motor for providing a driving force for pumping washing water can be penetration-coupled to a sump case mounted at a lower surface of the tub and having an accommodation space of washing water; and
inserting the sump case assembly into a penetration portion of the tub so that the sump case can be coupled to of the tub by hook assembly.

13. The assembly method of claim 12, wherein the step of completing the sump case assembly includes:
a first step of penetration-coupling the rotational shaft of the main motor to a lower portion of the sump case in which a heater for heating washing water is accommodated;
a second step of coupling a filth case for collecting filth to a lower side of a filter member for filtering filth;
a third step of coupling an impeller case in which an impeller is accommodated to a lower side of the filth case; and
a fourth step of coupling the filter member to an open portion of the sump case and fixedly-coupling the impeller to an upper end of the rotational shaft.

14. The method of claim 13 further comprising a fifth step of coupling a grinder for grinding foreign materials to the rotational shaft, arranging a conduit control valve for controlling a flow amount of washing water at a valve engaging portion formed at the sump case, and coupling a valve driving motor for driving the conduit control valve to the conduit control valve.
